(19) United States
(12) Patent Application Publication
(10) Pub. No.: US 2012/0141695 A1
(43) Pub. Date: Jun. 7, 2012

(54) MULTILAYERED RESIN PRODUCT AND IMAGE DISPLAY PANEL

(75) Inventor: Atsushi Kakinuma, Shinagawa-ku (JP)

(73) Assignee: SUMITOMO BAKELITE CO., LTD., Tokyo (JP)

(21) Appl. No.: 13/388,001

(22) PCT Filed: Apr. 30, 2010
(86) PCT No.: PCT/JP2010/057680

§ 371 Date: Feb. 10, 2012

(30) Foreign Application Priority Data
Jul. 31, 2009 (JP) 2009-179248

(51) Int. Cl. C09K 19/00; B32B 3/00

(52) U.S. Cl. 428/1.33; 428/336

(57) ABSTRACT

A multilayered resin product includes a resin substrate and a hard coat layer, wherein each side or one side of the resin substrate is coated with the hard coat layer, the hard coat layer includes a cured product of (A) a UV-curable compound and (B) a fatty acid, a fatty acid ester, or a derivative thereof, and the ratio “(Bs)/(As)” of the content (Bs) of the fatty acid, fatty acid ester, or derivative thereof to the content (As) of the cured product of the UV-curable compound in a surface area of the hard coat layer up to a depth of 100 nm is 0.07 to 3.3. The multilayered resin product may be used as a surface-protective multilayered resin product that advantageously prevents adhesion of stains due to adhesion of a sebum film without showing a decrease in the hard coat properties (e.g., scratch resistance and abrasion resistance) and the optical properties (e.g., transmittance and haze).

### TECHNICAL FIELD

The present invention relates to a multilayered resin product and an image display.

### BACKGROUND ART

A multilayered resin product has been used to protect a liquid crystal display of a cell phone, a digital camera, a digital video camera, a television, a personal computer, a portable game device, a global positioning system (GPS), or a touch panel, or the surface of goggles, a CD, a DVD, or the like. The surface of the multilayered resin product is normally subjected to a hard coat treatment for the purpose of preventing scratches and abrasions.

Since the hard coat layer (outermost surface) of the multilayered resin product comes in contact with skin during use, the surface of the hard coat layer may be stained due to adhesion of a sebum film that is formed of sebum and sweat (i.e., secretions from skin).

A method that incorporates a fluorine compound or a silicon compound in the hard coat layer to decrease adhesion of stains due to improved water repellency and oil repellency has been disclosed (see Patent Documents 1 and 2, for example).

However, it is very difficult to completely prevent adhesion of stains, and it is particularly difficult to prevent adhesion of stains due to adhesion of a sebum film. When the surface of the hard coat layer is stained due to a sebum film, reflected light is scattered due to the high contact angle of the stain, and the stain becomes more noticeable. Moreover, when decorating the multilayered resin product by printing characters, a pattern, or the like, screen printing or gravure printing cannot be used since the printing ink is repelled. Therefore, the application of the multilayered resin product is limited.

### RELATED-ART DOCUMENT

### Patent Document

Patent Document 1: Japanese Patent No. 3344199
Patent Document 2: JP-A-2007-160764

### SUMMARY OF THE INVENTION

### Problems to be Solved by the Invention

An object of the invention is to provide a multilayered resin product that advantageously prevents adhesion of stains due to adhesion of a sebum film without showing a decrease in the hard coat properties (e.g., scratch resistance and abrasion resistance) and the optical properties (e.g., transmittance and haze).

### Means for Solving the Problems

The above object is achieved by a multilayered resin product and an image display given below.

(1) A multilayered resin product including a resin substrate and a hard coat layer, each side or one side of the resin substrate being coated with the hard coat layer, the hard coat layer including a cured product of (A) a UV-curable compound and (B) a fatty acid, a fatty acid ester, or a derivative thereof, and a ratio “(Bs)/(As)” of a content (Bs) of the fatty acid, fatty acid ester, or derivative thereof to a content (As) of the cured product of the UV-curable compound in a surface area of the hard coat layer up to a depth of 100 nm being 0.07 to 3.3.
(2) The multilayered resin product according to (1), wherein the hard coat layer further includes (C) a modified polysiloxane compound.
(3) The multilayered resin product according to (1) or (2), wherein a ratio “(Cs)/(As)” of a content (Cs) of the modified polysiloxane compound to a content (As) of the cured product of the UV-curable compound in a surface area of the hard coat layer up to a depth of 100 nm is 0.0007 to 0.15.
(4) The multilayered resin product according to any one of (1) to (3), wherein the modified polysiloxane compound (C) is a polyether-modified polydimethylsiloxane and/or a polyether-modified polymethylalkylsiloxane.
(5) The multilayered resin product according to any one of (1) to (4), wherein a ratio “(Br)/(Ar)” of a content (Br) of the fatty acid, fatty acid ester, or derivative thereof to a content (Ar) of the cured product of the UV-curable compound in an area of the hard coat layer other than a surface area up to a depth of 100 nm is 0.08 or less.
(6) The multilayered resin product according to any one of (1) to (5), wherein a ratio “(Br)/(Ar)” of a content (Br) of the fatty acid, fatty acid ester, or derivative thereof to a content (Ar) of the cured product of the UV-curable compound in an area of the hard coat layer other than a surface area up to a depth of 100 nm is 0.03 or less.
(7) The multilayered resin product according to any one of (1) to (6), wherein the resin substrate includes an acrylic resin or a polycarbonate resin.
(8) An image display including the multilayered resin product according to any one of (1) to (7) in a display section of the image display.
(9) The image display according to (8), the image display being a cell phone.
(10) The image display according to (8), the image display being a liquid crystal display.

### Effects of the Invention

The invention thus provides a multilayered resin product that advantageously prevents adhesion of stains due to adhesion of a sebum film without showing a decrease in the hard coat properties (e.g., scratch resistance and abrasion resistance) and the optical properties (e.g., transmittance and haze).

### DESCRIPTION OF EXEMPLARY EMBODIMENTS

A multilayered resin product according to one embodiment of the invention includes a resin substrate and a hard coat later, wherein each side or one side of the resin substrate is coated with the hard coat layer, the hard coat layer includes a cured product of (A) a UV-curable compound and (B) a fatty acid, a fatty acid ester, or a derivative thereof (hereinafter referred to as “fatty acid or the like”), and a ratio “(Bs)/(As)” of a content (Bs) of the fatty acid or the like to a content (As) of the cured product of the UV-curable compound in a surface area of the hard coat layer up to a depth of 100 nm is 0.07 to 3.3. The multilayered resin product according to one embodiment of the invention can advantageously prevent adhesion of stains due to adhesion of a sebum film without showing a decrease in the hard coat properties (e.g., scratch resistance and abrasion resistance) and the optical properties (e.g., transmittance and haze).

The multilayered resin product according to one embodiment of the invention includes the resin substrate and the hard coat layer that is formed on each side or one side of the resin substrate.

The hard coat layer included in the multilayered resin product according to one embodiment of the invention includes a cured product of the UV-curable compound (A).

The UV-curable compound (A) is a compound that is cured by applying ultraviolet rays. The UV-curable compound (A) is a UV-curable oligomer, a UV-curable monomer, or a combination thereof. As the UV-curable oligomer, a compound that is normally used as a UV-curable oligomer that is cured by applying ultraviolet rays may be used. As the UV-curable monomer, a compound that is normally used as a UV-curable monomer that is cured by applying ultraviolet rays may be used.

The UV-curable oligomer is used for providing various properties (e.g., scratch resistance, abrasion resistance, impact resistance, workability, and flexibility) required of the hard coat layer.

Examples of the UV-curable oligomer include a urethane acrylate oligomer, an epoxy acrylate oligomer, a polyester acrylate oligomer, and the like.

The urethane acrylate oligomer may be obtained by reacting an acrylate monomer including a hydroxyl group with an isocyanate compound that is obtained by reacting a polyol and a diisocyanate, for example.

The epoxy acrylate oligomer may be obtained through an esterification reaction of acrylic acid and an oxirane ring of a low-molecular-weight bisphenol epoxy resin or a low-molecular-weight novolac epoxy resin, for example.

The polyester acrylate oligomer may be obtained by producing a polyester oligomer including a hydroxyl group at each end through condensation of a polycarboxylic acid and a polyhydric alcohol, and esterifying the hydroxyl group at each end with acrylic acid, for example.

The UV-curable oligomer is preferably a urethane acrylate oligomer, and more preferably a combination of a hexa- or higher functional UV-curable oligomer for achieving high hardness and a tri- or lower functional UV-curable oligomer for providing flexibility in terms of achieving a good balance between hardness and impact resistance.

The UV-curable oligomer preferably has a molecular weight of 300 to 30,000, and particularly preferably 500 to 10,000. Note that the molecular weight of the UV-curable oligomer refers to a weight average molecular weight measured by gel permeation chromatography (GPC).

Examples of the UV-curable compound (A) include a penta- or higher functional UV-curable monomer or a polymer thereof. The UV-curable compound (A) may also be a combination of a penta- or higher functional UV-curable monomer or a polymer thereof and a UV-curable oligomer.

When the UV-curable compound (A) is a penta- or higher functional UV-curable monomer, or a polymer thereof, or a combination of a penta- or higher functional UV-curable monomer or a polymer thereof and a UV-curable oligomer, various properties (e.g., scratch resistance, abrasion resistance, impact resistance, workability, and flexibility) required for the hard coat layer are improved.

The UV-curable compound (A) is particularly preferably a combination of a penta- or higher functional UV-curable monomer and a tri- or lower functional urethane acrylate oligomer in terms of achieving a good balance between hardness and impact resistance.

Examples of the penta- or higher functional UV-curable monomer or a polymer (e.g., dimer) thereof include dipentaerythritol pentaacrylate, dipentaerythritol hexaacrylate, tripentaerythritol heptaacrylate, tripentaerythritol octaacrylate, and the like.

The term “pentafunctional” used herein means that one molecule includes five functional groups (e.g., acrylic group, methacrylic group, or vinyl group) that undergo a polymerization reaction upon application of ultraviolet rays.

When using the above UV-curable monomer, it is possible to easily adjust the crosslink density or the viscosity of a UV-curable composition that forms the hard coat layer, and it is also possible to improve adhesion between the hard coat layer and the resin substrate.

Examples of the UV-curable monomer include pentaerythritol tetraacrylate, ditrimethylolpropane triacrylate, trimethylolpropane triacrylate, pentaerythritol triacrylate, dipentaerythritol triacrylate, ethoxylated trimethylolpropane triacrylate, ethoxylated pentaerythritol triacrylate, ethoxylated pentaerythritol tetraacrylate, polyethylene glycol diacrylate, ethoxylated bisphenol A diacrylate, ethoxylated hydrogenated bisphenol A diacrylate, ethoxylated cyclohexanedimethanol diacrylate, tricyclodecanedimethanol diacrylate, and the like.

Among these, a bifunctional acrylate having a cyclic structure is preferable in terms of improving the hardness and the heat resistance of the hard coat layer.

The hard coat layer included in the multilayered resin product according to one embodiment of the invention includes the fatty acid or the like (B). Accordingly, the cured product of the UV-curable compound (A) included in the hard coat layer includes the fatty acid or the like (B). Examples of the fatty acid or the like (B) include the following compounds. These compounds may be used either individually or in combination.

Examples of the fatty acid include lauric acid, myristic acid, palmitic acid, stearic acid, oleic acid, ricinoleic acid, linoleic acid, arachidic acid, lignoceric acid, and the like.

Examples of the fatty acid ester include glycerol fatty acid esters (monoglycerides), organic acid monoglycerides, polyglycerol fatty acid esters, sorbitan fatty acid esters, polyglycerol condensed ricinoleic acid esters, ethoxylated glycerol fatty acid esters, propylene glycol fatty acid esters, sucrose fatty acid esters, triolein, lecithin, and the like. Specific examples of the fatty acid ester include acetic acid monoglyceride, lactic acid monoglyceride, citric acid monoglyceride, diacetyltartaric acid monoglyceride, succinic acid monoglyceride, castor oil (ricinoleic acid triglyceride), polyoxyethylene hydrogenated castor oil, polyoxyethylene glyceryl isostearate, polyoxyethylene glyceryl tristearate, polyoxyethylene glyceryl diisostearate, lauric acid polyoxyethylene hydrogenated castor oil, isostearic acid polyoxyethylene hydrogenated castor oil, polyoxyethylene sorbitan tristearate, polyoxyethylene sorbitan trioleate, polyoxyethylene sorbitol tetraoleate, polyoxyethylene sorbitol tetrastearate, hydrogenated castor oil (hydrogenated ricinoleic acid triglyceride), polyoxyethylene castor oil, polyoxyethylene phytosterol, polyoxyethylene hydrogenated dimer dilinoleate, polyoxyethylene cholesteryl ether, polyoxyethylene decyl tetradecyl ether, and the like.

A derivative of a fatty acid is a compound in which some or all of the side-chain methyl groups of a fatty acid are substituted with another organic group. A derivative of a fatty acid ester is a compound in which some or all of the side-chain methyl groups of a fatty acid ester are substituted with another organic group. Examples of the organic group that may be included in a derivative of a fatty acid or a derivative of a fatty acid ester include a polyether group, a polyalkyl group, an aralkyl group, a polyester group, and the like. These groups may be used either individually or in combination.

The fatty acid or the like (B) is preferably a fatty acid, a fatty acid ester, or a derivative thereof that includes one or more (linear or cyclic) hydrocarbons having 12 or more carbon atoms and a polyether chain including 10 or more repeating units in total, and particularly preferably a fatty acid, a fatty acid ester, or a derivative thereof that includes two or more linear hydrocarbons having 16 to 18 carbon atoms and two or more polyether chains including 20 to 80 repeating units in total. Examples of such a fatty acid, fatty acid ester, or derivative thereof include polyoxyethylene glyceryl monostearate, polyoxyethylene glyceryl isostearate, polyoxyethylene glyceryl tristearate, polyoxyethylene glyceryl diisostearate, lauric acid polyoxyethylene hydrogenated castor oil, isostearic acid polyoxyethylene hydrogenated castor oil, polyoxyethylene sorbitan tristearate, polyoxyethylene sorbitan trioleate, polyoxyethylene sorbitol tetraoleate, polyoxyethylene sorbitol tetrastearate, polyoxyethylene castor oil, polyoxyethylene hydrogenated castor oil, polyoxyethylene phytosterol, polyoxyethylene cholesteryl ether, polyoxyethylene hydrogenated dimer dilinoleate, and the like.

The ratio “(Bs)/(As)” of the content (Bs) of the fatty acid or the like to the content (As) of the cured product of the UV-curable compound in a surface area of the hard coat layer up to a depth of 100 nm is 0.07 to 3.3, preferably 0.1 to 3, and more preferably 0.5 to 2.

If the ratio “(Bs)/(As)” is within the above range, it is possible to improve the effect of preventing noticeable stains due to adhesion of a sebum film, and achieve an effect of decreasing the contact angle of a sebum film that adheres to the surface of the hard coat layer so that the sebum film becomes less noticeable, and an effect of significantly improving removability of a sebum film. Moreover, a deterioration in optical properties (e.g., a decrease in transmittance or an increase in haze) does not occur due to sufficient durability (i.e., the performance of the hard coat layer is maintained), and the appearance does not deteriorate since the fatty acid or the like (B) does not appear on the surface of the hard coat layer.

Note that the ratio “(Bs)/(As)” is a weight ratio. When the hard coat layer includes only one type of fatty acid or the like, the ratio “(Bs)/(As)” is calculated using the content of the one type of fatty acid or the like. When the hard coat layer includes two or more types of fatty acid or the like, the ratio “(Bs)/(As)” is calculated using the total content of the two or more types of fatty acid or the like.

The surface area of the hard coat layer up to a depth of 100 nm refers to an area of the hard coat layer up to a depth of 100 nm that is opposite to the resin substrate. The area of the hard coat layer other than the surface area up to a depth of 100 nm refers to an area of the hard coat layer that is positioned on the side of the resin substrate as compared with the surface area up to a depth of 100 nm.

The ratio “(Bs)/(As)” of the content (Bs) of the fatty acid or the like to the content (As) of the cured product of the UV-curable compound in a surface area of the hard coat layer up to a depth of 100 nm is obtained by measuring the content (As) of the UV-curable compound and the content (Bs) of the fatty acid or the like in the surface area of the hard coat layer using time of flight-secondary ion mass spectroscopy (TOF-SIMS), and calculating the ratio “(Bs)/(As)” from the measured values.

The ratio “(Bs)/(As)” may be adjusted within the above range by appropriately adjusting the content (As) of the UV-curable compound (A) and the content (Bs) of the fatty acid or the like (B) in the UV-curable composition that forms the hard coat layer, for example.

Specifically, the ratio “(Bs)/(As)” may be adjusted within the above range by incorporating the fatty acid or the like (B) in the UV-curable composition in an amount of 0.01 to 5 parts by weight with respect to 100 parts by weight of the UV-curable compound (A), for example. The content (As) of the UV-curable compound and the content (Bs) of the fatty acid or the like may be appropriately adjusted depending on the thickness of the hard coat layer, or the kind or combination of the selected UV-curable compounds.

The ratio “(Br)/(Ar)” of the content (Br) of the fatty acid or the like to the content (Ar) of the cured product of the UV-curable compound in the area of the hard coat layer other than a surface area up to a depth of 100 nm is 0.08 or less, preferably 0.03 or less, and particularly preferably more than 0 and 0.01 or less.

The ratio “(Br)/(Ar)” is calculated by the following formula.

$$\frac{Br}{Ar} = \frac{( Bt ) - ( \frac{( At + Bt )}{t} \times 0.1 \times \frac{\frac{Bs}{As}}{\frac{As}{As} + \frac{Bs}{As}} )}{( At ) - ( \frac{( At + Bt )}{t} \times 0.1 \times \frac{\frac{As}{As}}{\frac{As}{As} + \frac{Bs}{As}} )} \qquad ( 1 )$$

where,
At is the content (weight) of the component (A) in the entire hard coat layer,
Bt is the content (weight) of the component (B) in the entire hard coat layer,
t is the thickness (μm) of the hard coat layer,
As is the content (weight) of the component (A) in a surface area of the hard coat layer up to a depth of 100 nm, and
Bs is the content (weight) of the component (B) in a surface area of the hard coat layer up to a depth of 100 nm.

Note that the content of the component (A) in the entire hard coat layer refers to the total content of the component (A) included in a surface area of the hard coat layer up to a depth of 100 nm and the component (A) included in an area of the hard coat layer other than a surface area up to a depth of 100 nm. Similarly, the content of the component (B) in the entire hard coat layer refers to the total content of the component (B) included in a surface area of the hard coat layer up to a depth of 100 nm and the component (B) included in the area of the hard coat layer other than a surface area up to a depth of 100 nm.

In the multilayered resin product according to one embodiment of the invention, the concentration of at least one compound selected from the fatty acid or the like (B) in a surface area of the hard coat layer up to a depth of 100 nm is higher than that in an area of the hard coat layer other than a surface area up to a depth of 100 nm.

If the fatty acid or the like (B) is included in a deeper area of the hard coat layer at a high concentration, it is possible to achieve the effect of decreasing the contact angle of a sebum film that adheres to the surface so that the sebum film becomes less noticeable, and the effect of significantly improving removability of a sebum film, but the optical properties may deteriorate (e.g., a decrease in transmittance or an increase in haze may occur), or the performance of the hard coat may deteriorate. This may hinder the application of the multilayered resin product according to one embodiment of the invention.

It is preferable that the hard coat layer included in the multilayered resin product according to one embodiment of the invention further include (C) a modified polysiloxane compound. The modified polysiloxane compound (C) is a compound including polydimethylsiloxane as a basic structure wherein some or all of the side-chain methyl groups of polydimethylsiloxane are substituted with another organic group. Examples of the organic group included in the modified polysiloxane compound (C) include a polyether group, a polyalkyl group, an aralkyl group, a polyester group, and the like. These groups may be included in the modified polysiloxane compound (C) either individually or in combination.

The modified polysiloxane compound (C) is preferably a polyether-modified polydimethylsiloxane or a polyether-modified polymethylalkylsiloxane. The polyether group (organic group) that may be included in the modified polysiloxane compound (C) includes a homopolymer of ethylene oxide or propylene oxide or a copolymer of ethylene oxide or propylene oxide.

The ratio “(Cs)/(As)” of the content (Cs) of the modified polysiloxane compound to the content (As) of the cured product of the UV-curable compound in a surface area of the hard coat layer up to a depth of 100 nm is 0.0007 to 0.15, preferably 0.001 to 0.1, and more preferably 0.005 to 0.05.

If the ratio “(Cs)/(As)” is within the above range, it is possible to improve the effect of decreasing the contact angle of a sebum film that adheres to the surface of the hard coat layer so that the sebum film becomes less noticeable, and the effect of significantly improving removability of a sebum film, and achieve high durability. Moreover, the performance of the hard coat layer increases since the smoothness (flatness) of the hard coat layer is easily achieved.

The ratio “(Cs)/(As)” in a surface area of the hard coat layer up to a depth of 100 nm is adjusted within the above range by appropriately adjusting the content (As) of the UV-curable compound and the content (Cs) of the modified polysiloxane compound. For example, the ratio “(Cs)/(As)” in a surface area of the hard coat layer up to a depth of 100 nm may be adjusted within the above range by adjusting the amount of the modified polysiloxane compound (C) to 0.0001 to 0.3 parts by weight with respect to 100 parts by weight of the UV-curable compound (A).

Note that the term “sebum film” refers to a film that is formed on the surface of the skin when sebum secreted from a sebaceous gland is mixed with sweat secreted from a sweat gland. The sebum film includes 7.9 to 39.0% of fatty acids, 9.5 to 49.4% of triglycerides, 2.3 to 4.3% of diglycerides/monoglycerides, 22.6 to 29.5% of wax esters, 1.5 to 2.6% of cholesterol esters, 1.2 to 2.3% of cholesterol, and 10.1 to 13.9% of squalene, for example. 85% or more (i.e., components other than squalene and cholesterol) of the sebum film are fatty acids or fatty acid ester derivatives. A triglyceride is a compound in which glycerol and three fatty acids are bonded via an ester bond, a diglyceride is a compound in which glycerol and two fatty acids are bonded via an ester bond, and a monoglyceride is a compound in which glycerol and one fatty acid are bonded via an ester bond. A wax ester is a compound in which a fatty acid and a higher alcohol are bonded via an ester bond. A cholesterol ester is a compound in which a fatty acid and cholesterol are bonded via an ester bond.

If the cured product of the UV-curable compound (A) includes the modified polysiloxane compound (C), but does not include the fatty acid or the like (B), a multilayered resin product that has a smooth (flat) surface and exhibits sufficient optical properties (e.g., transmittance and haze) due to the modified polysiloxane compound (C) can be obtained. However, removability of a sebum film is only slightly improved as compared with a case where the cured product does not include the modified polysiloxane compound (C), and it is impossible to achieve the effect of decreasing the contact angle of a sebum film that adheres to the surface so that the sebum film becomes less noticeable, and the effect of significantly improving the removability of a sebum film.

The multilayered resin product according to one embodiment of the invention exhibits an improved effect of decreasing the contact angle of a sebum film that adheres to the surface so that the sebum film becomes less noticeable, has surface smoothness (flatness), and exhibits an improved effect of improving removability of a sebum film without showing a decrease in optical properties (e.g., transmittance and haze) when the cured product of the UV-curable compound (A) that forms the hard coat layer includes the fatty acid or the like (B) and the modified polysiloxane compound (C) (i.e., compounds having affinity to a sebum film). The above effects are improved when the cured product of the UV-curable compound (A) that forms the hard coat layer includes the fatty acid or the like (B) and the modified polysiloxane compound (C) at a high concentration in a surface area of the hard coat layer.

The thickness of the hard coat layer is preferably 1 to 50 μm. If the thickness of the hard coat layer is within the above range, the UV-curable compound can be cured uniformly and deeply inside the hard coat layer by applying ultraviolet rays. Moreover, good adhesion between the hard coat layer and the multilayered resin product is achieved, and cracks and the like due to the cure shrinkage of the film hardly ever occur.

The hard coat layer included in the multilayered resin product according to one embodiment of the invention is formed on the surface of the multilayered resin product by applying the UV-curable composition to the surface of the resin substrate, and curing the UV-curable composition by applying ultraviolet rays.

The UV-curable composition used for forming the hard coat layer included in the multilayered resin product according to one embodiment of the invention includes the UV-curable compound (A) and the fatty acid or the like (B). It is preferable that the UV-curable composition further include the modified polysiloxane compound (C) in addition to the UV-curable compound (A) and the fatty acid or the like (B). The content of the UV-curable compound, the content of the fatty acid or the like, and the content of the modified polysiloxane compound in the UV-curable composition are appropriately selected depending on the desired ratio “(Bs)/(As)” or “(Cs)/(As)”.

The UV-curable composition may include a photoinitiator. The photoinitiator is added to the UV-curable composition in order to initiate the reaction (polymerization) of the UV-curable composition by applying ultraviolet rays.

Examples of the photoinitiator include benzoins or benzoin alkyl ethers such as benzoin, benzoin methyl ether, and benzoin isopropyl ether, aromatic ketones such as benzophenone and benzoylbenzoic acid, a-dicarbonyls such as benzyl, benzyl ketals such as benzyl dimethyl ketal and benzyl diethyl ketal, acetophenones such as acetophenone, 1-(4-dodecylphenyl)-2-hydroxy-2-methylpropan-1-one, 1-hydroxycyclohexyl phenyl ketone, 2-hydroxy-2-methyl-1-phenyl-1-propan-1-one, 1-(4-isopropylphenyl)-2-hydroxy-2-methyl-propan-1-one, and 2-methyl-1-[4-(methylthio)phenyl]-2-morpholinopropanone-1, anthraquinones such as 2-methylanthraquinone, 2-ethylanthraquinone, and 2-t-butylanthraquinone, thioxanthones such as 2,4-dimethylthioxanthone, 2-isopropylthioxanthone, and 2,4-diisopropylthioxanthone, phosphine oxides such as bis(2,4,6-trimethylbenzoyl)-phenylphosphine oxide, α-acyloximes such as 1-phenyl-1,2-propanedione-2-[o-ethoxycarbonyl]oxime, amines such as ethyl p-dimethylaminobenzoate and isoamyl p-dimethylaminobenzoate, and the like. It is preferable to use at least a photoinitiator that exhibits excellent surface curability and a photoinitiator that exhibits excellent internal curability in combination.

The UV-curable composition may include a surface conditioner, a diluting solvent, an inorganic or organic filler, and the like in addition to the above components.

The surface conditioner is optionally added to the UV-curable composition in order to form a smooth (flat) film to obtain a good appearance. As the surface conditioner, a small amount of a fluorine compound or an acrylic copolymer may be used, for example.

The UV-curable composition used for forming the hard coat layer included in the multilayered resin product according to one embodiment of the invention may be a dispersion or a solution in which the above components are dispersed or dissolved in a solvent.

The solvent is optionally added to the UV-curable composition so that the UV-curable composition can be easily applied to the multilayered resin product.

Examples of the solvent include aliphatic hydrocarbons such as hexane, heptane, and cyclohexane, aromatic hydrocarbons such as toluene and xylene, alcohols such as methanol, ethanol, propanol, and butanol, ketones such as methyl ethyl ketone, 2-pentanone, and isophorone, esters such as ethyl acetate, butyl acetate, and methoxypropyl acetate, cellosolve solvents such as ethyl cellosolve, and glycol solvents such as methoxypropanol, ethoxypropanol, and methoxybutanol. These solvents may be used either individually or in combination.

The UV-curable composition used for forming the hard coat layer may be produced by weighing and mixing the components (A), (B), and (C), the photoinitiator, and an additional optional component (e.g., surface conditioner, diluting solvent, or inorganic or organic filler), and stirring the mixture so as to produce a homogenous UV-curable composition, for example.

For example, the components may be mixed, optionally heated (preferably 60° C. or less), and stirred using a stirrer (e.g., dissolver) or a dispersing apparatus (e.g., ball mill) (e.g., for about 1 to 30 minutes) until the mixture becomes homogenous to produce the UV-curable composition.

The resin substrate included in the multilayered resin product according to one embodiment of the invention is not particularly limited provided that the resin substrate is made of a normal resin.

The multilayered resin product according to one embodiment of the invention may be used for a liquid crystal display of a cell phone, a digital camera, a digital video camera, a television, a personal computer, a portable game device, a global positioning system (GPS), a touch panel, or the like, a protective cover for goggles, a CD, a DVD, or the like. The resin substrate is preferably made of an acrylic resin or a polycarbonate resin in terms of transparency, workability, and impact resistance. The resin substrate may also preferably made of a normal transparent resin such as a polyethylene terephthalate resin, a polyvinyl chloride resin, or a polystyrene resin.

The thickness of the resin substrate is not particularly limited, but is preferably 0.02 to 2 mm in order to make the resin substrate smaller and thinner while maintaining the performance (e.g., impact resistance and workability) required for the above applications.

The hard coat layer included in the multilayered resin product according to one embodiment of the invention may be formed by an arbitrary method. For example, the hard coat layer may be formed by applying the UV-curable composition to each side or one side of the resin substrate by a known method (e.g., roll coating, flow coating, spray coating, curtain coating, dip coating, or die coating), and curing the UV-curable composition by applying ultraviolet rays.

When the UV-curable composition includes a diluting solvent, the hard coat layer may be formed by applying the UV-curable composition to the resin substrate, sufficiently evaporating the diluting solvent by increasing the temperature of the resin substrate and the atmosphere to form a film, and curing the film by applying ultraviolet rays, for example. Ultraviolet rays may be applied using a high-voltage mercury lamp with or without an electrode, a metal halide lamp, or the like. A low-voltage (e.g., about 100 KeV) electron beam irradiation device may also be used. When using electron beams for curing the UV-curable composition, there is no need to use the photoinitiator.

The thickness of the film formed by applying the UV-curable composition to the resin substrate is not particularly limited, but is preferably 1 to 50 μm so that the hard coat layer exhibits practical performance. If the thickness of the film of the UV-curable composition exceeds 50 μm, it may be difficult to uniformly cure the deep area of the film by applying ultraviolet rays. Also, adhesion between the hard coat layer and the multilayered resin product may deteriorate, or cracks and the like may occur due to the cure shrinkage of the film

The thickness of the multilayered resin product according to one embodiment of the invention is not particularly limited, but is preferably 0.02 to 2 mm in order to make the multilayered resin product smaller and thinner while maintaining the performance (e.g., impact resistance and workability) required for the above applications. A thickness within the above range is particularly useful for protective covers.

An image display according to one embodiment of the invention includes a display section in which the multilayered resin product according to one embodiment of the invention is used. The image display is preferably a cell phone or a liquid crystal display.

### EXAMPLES

The invention is further described below by way of examples and comparative examples. Note that the invention is not limited to the following examples.

The following raw materials were used.

### UV-Curable Compound (A)

(A1) Hexafunctional urethane acrylate oligomer (“EB1290” manufactured by Daicel-Cytec Co., Ltd.) (UV-curable oligomer)
(A2) Bifunctional urethane acrylate oligomer (“EB8402” manufactured by Daicel-Cytec Co., Ltd.) (UV-curable oligomer)
(A3) Dipentaerythritol hexaacrylate (“A-DPH” manufactured by Shin-Nakamura Chemical Co., Ltd.) (UV-curable monomer)
(A4) Pentaerythritol tetraacrylate (“A-TMMT” manufactured by Shin-Nakamura Chemical Co., Ltd.) (UV-curable monomer)
(A5) Ethoxylated bisphenol A diacrylate (“A-BPE-4” manufactured by Shin-Nakamura Chemical Co., Ltd.) (UV-curable monomer)

### Fatty Acid, Fatty Acid Ester, or Derivative Thereof (B)

(B1) Polyoxyethylene glyceryl isostearate (“GWIS-110” manufactured by Nihon Emulsion Co., Ltd.)
(B2) Polyoxyethylene glyceryl tristearate (“GWS320” manufactured by Nihon Emulsion Co., Ltd.)
(B3) Polyoxyethylene glyceryl diisostearate (“GWIS-260EX” manufactured by Nihon Emulsion Co., Ltd.)
(B4) Laurie acid polyoxyethylene hydrogenated castor oil (“RWL-150” manufactured by Nihon Emulsion Co., Ltd.)
(B5) Isostearic acid polyoxyethylene hydrogenated castor oil (“EMALEX RWIS-10” manufactured by Nihon Emulsion Co., Ltd.)
(B6) Polyoxyethylene sorbitol tetraoleate (“EMANON 460V” manufactured by Kao Corporation)
(B7) Polyoxyethylene sorbitol tetrastearate (“NIKKOL GS460” manufactured by Nikko Chemicals Co., Ltd.)
(B8) Polyoxyethylene castor oil (“C-40” manufactured by Nihon Emulsion Co., Ltd.)
(B9) Polyoxyethylene hydrogenated castor oil (“EMANON CH-60” manufactured by Kao Corporation)
(B10) Polyoxyethylene phytosterol (“NIKKOL BPS-10” manufactured by Nikko Chemicals Co., Ltd.)
(B11) Polyoxyethylene hydrogenated dimer dilinoleate (“EMALEX DICD-30” manufactured by Nihon Emulsion Co., Ltd.)

### Modified Polysiloxane Compound (C)

(C1) Modified polysiloxane compound (“SH28PA” manufactured by Dow Corning Toray Co., Ltd.)
(C2) Modified polysiloxane compound (“Granol 400” manufactured by Kyoeisha Chemical Co., Ltd.)

### Photoinitiator

1-Hydroxycyclohexyl phenyl ketone (“Irgacure 184” manufactured by Ciba Japan K.K.)

### Example 1

EB1290, EB8402, A-TMMT, and A-BPE-4 (UV-curable compound (A)) were mixed in a ratio of 40/10/40/10, and diluted with a propylene glycol monomethyl ether/isobutyl alcohol (=50/50) mixed diluting solvent so that the concentration of the UV-curable compound was 20 wt %. Irgacure 184 (photoinitiator) was added to the mixture in an amount of 5 wt % with respect to the UV-curable compound. After the addition of polyoxyethylene glyceryl isostearate (GWIS-110) (fatty acid or the like (B)) in the amount shown in Table 1, the mixture was sufficiently stirred to prepare a UV-curable composition. The UV-curable composition was stored in an airtight container.

An acrylic resin (PMMA) substrate having a thickness of 1.5 mm (“Sumipex E” manufactured by Sumitomo Chemical Co., Ltd.) was provided as a resin substrate. The UV-curable composition was applied to the resin substrate using a bar coater so that the thickness of the resulting wet film was about 15 μm.

The resin substrate to which the UV-curable composition had been applied was placed in a hot-air circulation oven, and dried at 50° C. for 10 minutes. The film was cured by applying ultraviolet rays using a metal halide lamp (manufactured by USHIO INC.) to obtain a multilayered resin product including a hard coat layer having a thickness of 3 μm. The content (As) of the cured product of the UV-curable compound and the content (Bs) of the fatty acid or the like in a surface area of the hard coat layer up to a depth of 100 nm were measured. The ratio “(Bs)/(As)” was calculated to be 1.1.

The ratio “(Br)/(Ar)” of the content (Br) of the fatty acid or the like to the content (Ar) of the cured product of the UV-curable compound in an area of the hard coat layer other than a surface area up to a depth of 100 nm was calculated by the formula (1), and found to be 0.08 or less.

### Example 2

A multilayered resin product including a hard coat layer having a thickness of 3 μm was obtained in the same manner as in Example 1, except for changing the ratio of EB1290, EB8402, A-TMMT, and A-BPE-4 (UV-curable compound (A)) to 55/5/30/10, and using polyoxyethylene glyceryl tristearate (GWS320) (fatty acid or the like (B)) instead of GWIS-110.

The content (As) of the cured product of the UV-curable compound and the content (Bs) of the fatty acid or the like in a surface area of the hard coat layer up to a depth of 100 nm were measured. The ratio “(Bs)/(As)” was calculated to be 0.9. The ratio “(Br)/(Ar)” of the content (Br) of the fatty acid or the like to the content (Ar) of the cured product of the UV-curable compound in an area of the hard coat layer other than a surface area up to a depth of 100 nm was calculated by the formula (I), and found to be 0.08 or less.

### Example 3

A multilayered resin product including a hard coat layer having a thickness of 5 μm was obtained in the same manner as in Example 1, except for using polyoxyethylene glyceryl diisostearate (GWIS-260EX) (fatty acid or the like (B)) instead of GWIS-110, adding GWIS-260EX and SH28PA (modified polysiloxane compound (C)) in the amounts shown in Table 1, and applying the UV-curable composition to the resin substrate so that the thickness of the resulting wet film was about 25 μm.

The content (As) of the cured product of the UV-curable compound and the content (Bs) of the fatty acid or the like in a surface area of the hard coat layer up to a depth of 100 nm were measured, and the ratio “(Bs)/(As)” was calculated to be 1.0. The ratio “(Cs)/(As)” of the content (Cs) of the modified polysiloxane compound to the content (As) of the cured product of the UV-curable compound in a surface area of the hard coat layer up to a depth of 100 nm was 0.005.

The ratio “(Br)/(Ar)” of the content (Br) of the fatty acid or the like to the content (Ar) of the cured product of the UV-curable compound in an area of the hard coat layer other than a surface area up to a depth of 100 nm was calculated by the formula (1), and found to be 0.08 or less.

### Example 4

A multilayered resin product including a hard coat layer having a thickness of 5 μm was obtained in the same manner as in Example 3, except for using A-DPH (UV-curable compound (A)) instead of EB1290, using lauric acid polyoxyethylene hydrogenated castor oil (RWL-150) (fatty acid or the like (B)) instead of GWIS-260EX, adding SH28PA as the modified polysiloxane compound (C), and applying the UV-curable composition to the resin substrate so that the thickness of the resulting wet film was about 25 μm.

The content (As) of the cured product of the UV-curable compound and the content (Bs) of the fatty acid or the like in a surface area of the hard coat layer up to a depth of 100 nm were measured, and the ratio “(Bs)/(As)” was calculated to be 2.1. The ratio “(Cs)/(As)” of the content (Cs) of the modified polysiloxane compound to the content (As) of the cured product of the UV-curable compound in a surface area of the hard coat layer up to a depth of 100 nm was 0.05.

The ratio “(Br)/(Ar)” of the content (Br) of the fatty acid or the like to the content (Ar) of the cured product of the UV-curable compound in an area of the hard coat layer other than a surface area up to a depth of 100 nm was calculated by the formula (1), and found to be 0.08 or less.

### Example 5

A multilayered resin product including a hard coat layer having a thickness of 5 μm was obtained in the same manner as in Example 3, except for using isostearic acid polyoxyethylene hydrogenated castor oil (RWIS-10) (fatty acid or the like (B)) instead of GWIS-260EX, using a propylene glycol monomethyl ether/isobutyl alcohol (=80/20) mixed diluting solvent instead of a propylene glycol monomethyl ether/isobutyl alcohol (=50/50) mixed diluting solvent, using a polycarbonate resin (PC) substrate having a thickness of 0.5 mm (“Polyca-Ace” manufactured by Sumitomo Bakelite Co., Ltd.) (resin substrate) instead of Sumipex E, and drying the resin substrate at 70° C. for 5 minutes.

The content (As) of the cured product of the UV-curable compound and the content (Bs) of the fatty acid or the like in a surface area of the hard coat layer up to a depth of 100 nm were measured, and the ratio “(Bs)/(As)” was calculated to be 3. The ratio “(Cs)/(As)” of the content (Cs) of the modified polysiloxane compound to the content (As) of the cured product of the UV-curable compound in a surface area of the hard coat layer up to a depth of 100 nm was 0.1.

The ratio “(Br)/(Ar)” of the content (Br) of the fatty acid or the like to the content (Ar) of the cured product of the UV-curable compound in an area of the hard coat layer other than a surface area up to a depth of 100 nm was calculated by the formula (1), and found to be 0.08 or less.

### Example 6

A multilayered resin product including a hard coat layer having a thickness of 5 μm was obtained in the same manner as in Example 3, except for using polyoxyethylene sorbitol tetraoleate (460VG) (fatty acid or the like (B)) instead of GWIS-260EX, using Granol 400 (modified polysiloxane compound (C)) instead of SH28PA, and using a polyethylene terephthalate resin (PET) substrate having a thickness of 188 μm (“COSMOSHINE A4300” manufactured by Toyobo Co., Ltd.) (resin substrate) instead of Sumipex E.

The content (As) of the cured product of the UV-curable compound and the content (Bs) of the fatty acid or the like in a surface area of the hard coat layer up to a depth of 100 nm were measured, and the ratio “(Bs)/(As)” was calculated to be 0.1. The ratio “(Cs)/(As)” of the content (Cs) of the modified polysiloxane compound to the content (As) of the cured product of the UV-curable compound in a surface area of the hard coat layer up to a depth of 100 nm was 0.001.

The ratio “(Br)/(Ar)” of the content (Br) of the fatty acid or the like to the content (Ar) of the cured product of the UV-curable compound in an area of the hard coat layer other than a surface area up to a depth of 100 nm was calculated by the formula (1), and found to be 0.08 or less.

### Example 7

A multilayered resin product including a hard coat layer having a thickness of 5 μm was obtained in the same manner as in Example 3, except for using A-DCP, EB8402, A-TMMT, and A-BPE-4 (UV-curable compound (A)) in a ratio of 70/10/10/10, using polyoxyethylene sorbitol tetrastearate (GS460) (fatty acid or the like (B)) instead of GWIS-260EX, and using Granol 400 (modified polysiloxane compound (C)) instead of SH28PA.

The content (As) of the cured product of the UV-curable compound and the content (Bs) of the fatty acid or the like in a surface area of the hard coat layer up to a depth of 100 nm were measured, and the ratio “(Bs)/(As)” was calculated to be 0.5. The ratio “(Cs)/(As)” of the content (Cs) of the modified polysiloxane compound to the content (As) of the cured product of the UV-curable compound in a surface area of the hard coat layer up to a depth of 100 nm was 0.005.

The ratio “(Br)/(Ar)” of the content (Br) of the fatty acid or the like to the content (Ar) of the cured product of the UV-curable compound in an area of the hard coat layer other than a surface area up to a depth of 100 nm was calculated by the formula (1), and found to be 0.08 or less.

### Example 8

A multilayered resin product including a hard coat layer having a thickness of 8 μm was obtained in the same manner as in Example 7, except for using EB1290, A-DCP, EB8402, A-TMMT, and A-BPE-4 (UV-curable compound (A)) in a ratio of 30/30/20/10/10, using polyoxyethylene castor oil (C-40) (fatty acid or the like (B)) instead of GS460, and applying the UV-curable composition to the resin substrate so that the thickness of the resulting wet film was about 40 μm.

The content (As) of the cured product of the UV-curable compound and the content (Bs) of the fatty acid or the like in a surface area of the hard coat layer up to a depth of 100 nm were measured, and the ratio “(Bs)/(As)” was calculated to be 1.8. The ratio “(Cs)/(As)” of the content (Cs) of the modified polysiloxane compound to the content (As) of the cured product of the UV-curable compound in a surface area of the hard coat layer up to a depth of 100 nm was 0.03.

The ratio “(Br)/(Ar)” of the content (Br) of the fatty acid or the like to the content (Ar) of the cured product of the UV-curable compound in an area of the hard coat layer other than a surface area up to a depth of 100 nm was calculated by the formula (1), and found to be 0.08 or less.

### Example 9

A multilayered resin product including a hard coat layer having a thickness of 8 μm was obtained in the same manner as in Example 7, except for using EB1290, A-DCP, EB8402, and A-BPE-4 (UV-curable compound (A)) in a ratio of 25/30/25/20, and using polyoxyethylene hydrogenated castor oil (CH-60) (fatty acid or the like (B)) instead of GS460.

The content (As) of the cured product of the UV-curable compound and the content (Bs) of the fatty acid or the like in a surface area of the hard coat layer up to a depth of 100 nm were measured, and the ratio “(Bs)/(As)” was calculated to be 0.8. The ratio “(Cs)/(As)” of the content (Cs) of the modified polysiloxane compound to the content (As) of the cured product of the UV-curable compound in a surface area of the hard coat layer up to a depth of 100 nm was 0.015.

The ratio “(Br)/(Ar)” of the content (Br) of the fatty acid or the like to the content (Ar) of the cured product of the UV-curable compound in an area of the hard coat layer other than a surface area up to a depth of 100 inn was calculated by the formula (1), and found to be 0.08 or less.

### Example 10

A multilayered resin product including a hard coat layer having a thickness of 3 μm was obtained in the same manner as in Example 7, except for using polyoxyethylene phytosterol (BPS-10) (fatty acid or the like (B)) instead of GS460, and applying the UV-curable composition to the resin substrate so that the thickness of the resulting wet film was about 15 μm.

The content (As) of the cured product of the UV-curable compound and the content (Bs) of the fatty acid or the like in a surface area of the hard coat layer up to a depth of 100 nm were measured, and the ratio “(Bs)/(As)” was calculated to be 1.5. The ratio “(Cs)/(As)” of the content (Cs) of the modified polysiloxane compound to the content (As) of the cured product of the UV-curable compound in a surface area of the hard coat layer up to a depth of 100 nm was 0.02.

The ratio “(Br)/(Ar)” of the content (Br) of the fatty acid or the like to the content (Ar) of the cured product of the UV-curable compound in an area of the hard coat layer other than a surface area up to a depth of 100 nm was calculated by the formula (1), and found to be 0.08 or less.

### Example 11

A multilayered resin product including a hard coat layer having a thickness of 3 μm was obtained in the same manner as in Example 10, except for using polyoxyethylene hydrogenated dimer dilinoleate (DICD-30) (fatty acid or the like (B)) instead of BPS-10.

The content (As) of the cured product of the UV-curable compound and the content (Bs) of the fatty acid or the like in a surface area of the hard coat layer up to a depth of 100 nm were measured, and the ratio “(Bs)/(As)” was calculated to be 2.3. The ratio “(Cs)/(As)” of the content (Cs) of the modified polysiloxane compound to the content (As) of the cured product of the UV-curable compound in a surface area of the hard coat layer up to a depth of 100 nm was 0.07.

The ratio “(Br)/(Ar)” of the content (Br) of the fatty acid or the like to the content (Ar) of the cured product of the UV-curable compound in an area of the hard coat layer other than a surface area up to a depth of 100 nm was calculated by the formula (1), and found to be 0.08 or less.

### Comparative Example 1

A multilayered resin product including a hard coat layer having a thickness of 3 μm was obtained in the same manner as in Example 1, except for adding polyoxyethylene glyceryl isostearate (GWIS-110) (fatty acid or the like (B)) in the amount shown in Table 2.

The content (As) of the cured product of the UV-curable compound and the content (Bs) of the fatty acid or the like in a surface area of the hard coat layer up to a depth of 100 nm were measured. The ratio “(Bs)/(As)” was calculated to be 3.6.

### Comparative Example 2

A multilayered resin product including a hard coat layer having a thickness of 5 μm was obtained in the same manner as in Example 3, except for adding polyoxyethylene glyceryl diisostearate (GWIS-260EX) (fatty acid or the like (B)) in the amount shown in Table 2.

The content (As) of the cured product of the UV-curable compound and the content (Bs) of the fatty acid or the like in a surface area of the hard coat layer up to a depth of 100 nm were measured, and the ratio “(Bs)/(As)” was calculated to be 0.05. The ratio “(Cs)/(As)” of the content (Cs) of the modified polysiloxane compound to the content (As) of the cured product of the UV-curable compound in a surface area of the hard coat layer up to a depth of 100 nm was 0.005.

### Comparative Example 3

A multilayered resin product including a hard coat layer having a thickness of 5 μm was obtained in the same manner as in Example 7, except for not adding the fatty acid or the like (B).

The content (As) of the cured product of the UV-curable compound and the content (Cs) of the modified polysiloxane compound in a surface area of the hard coat layer up to a depth of 100 nm were measured, and the ratio “(Cs)/(As)” was calculated to be 0.005.

### Comparative Example 4

A multilayered resin product including a hard coat layer having a thickness of 5 μm was obtained in the same manner as in Example 7, except for adding the fatty acid or the like (B) and the modified polysiloxane compound (C) in the amounts shown in Table 2.

The content (As) of the cured product of the UV-curable compound and the content (Bs) of the fatty acid or the like in a surface area of the hard coat layer up to a depth of 100 nm were measured, and the ratio “(Bs)/(As)” was calculated to be 4.3. The ratio “(Cs)/(As)” of the content (Cs) of the modified polysiloxane compound to the content (As) of the cured product of the UV-curable compound in a surface area of the hard coat layer up to a depth of 100 nm was 0.2.

### Reference Example 1

A multilayered resin product including a hard coat layer having a thickness of 5 μm was obtained in the same manner as in Example 7, except for adding the fatty acid or the like (B) and the modified polysiloxane compound (C) in the amounts shown in Table 2.

The content (As) of the cured product of the UV-curable compound and the content (Bs) of the fatty acid or the like in a surface area of the hard coat layer up to a depth of 100 nm were measured, and the ratio “(Bs)/(As)” was calculated to be 0.5. The ratio “(Cs)/(As)” of the content (Cs) of the modified polysiloxane compound to the content (As) of the cured product of the UV-curable compound in a surface area of the hard coat layer up to a depth of 100 nm was 0.3.

The multilayered resin products thus obtained were evaluated as follows.

### Measurement of the Ratios “(Bs)/(As)” and “(Cs)/(As)”

The content of each component in a surface area of the hard coat layer up to a depth of 100 nm was measured by time of flight-secondary ion mass spectroscopy (TOF-SIMS). Specifically, the content of each component in a surface area of the hard coat layer up to a depth of 100 nm was measured while subjecting the surface of the multilayered resin product sample to ion-beam sputtering. A characteristic peak was specified using each component in advance, and taken as the measurement peak. The average content from the outermost surface to a depth of 100 nm was used as the content of each component. The ratio was calculated on a weight basis.

### Appearance and Surface Cloudiness

The multilayered resin product was observed with the naked eye at a distance of 10 cm under a three-wavelength fluorescent lamp (20 W) in a darkroom to confirm the presence or absence of cloudiness of the surface of the hard coat layer, the presence or absence of precipitates on the surface of the hard coat layer, and the smoothness (flatness) of the surface of the hard coat layer.

### Optical Properties

The total light transmittance (Tt) and the haze (Hz) of the multilayered resin product were measured using a haze meter (“NDH2000” manufactured by Nippon Denshoku Industries Co., Ltd.) in accordance with JIS K 7105.

### Hard Coat Properties

A retainer (diameter: 10 mm) to which #0000 steel wool was attached, was reciprocated on the surface of the multilayered resin product 100 times at a constant load (500 g) and a constant speed (6000 mm/min). The presence or absence of scratches on the surface of the multilayered resin product was observed with the naked eye, and evaluated according to the following criteria.

A: No scratches occurred (i.e., excellent in practice)
B: Some scratches occurred (i.e., sufficient in practice)
C: Scratches occurred over the entire surface (i.e., poor in practice)

### Sebum Film Stain Resistance

### Sebum Film Stain Resistance I (Degree of Noticeability/Visibility of Stains)

An index finger to which triolein (sebum component) had adhered was pressed against the surface of the hard coat layer of the multilayered resin product at a constant load (1 kg) to transfer the triolein to the surface of the hard coat layer. The surface of the hard coat layer to which the triolein was transferred was observed using a microscope (“VK9700” manufactured by Keyence Corporation) at a magnification of 200.

The sebum film stain resistance was evaluated according to the following criteria based on the triolein adhesion state.

A: 70% or more of the area of the triolein adhering in a fingerprint pattern was spread over the laminate (i.e., did not form a droplet having a diameter of 100 μm or less) (i.e., the fingerprint pattern was much less visible).
B: 50% or more and less than 70% of the area of the triolein adhering in a fingerprint pattern was spread over the laminate (i.e., did not form a droplet having a diameter of 100 μm or less) (i.e., the fingerprint pattern was less visible).
C: More than 50% of the area of the triolein adhering in a fingerprint pattern formed a droplet having a diameter of 100 μm or less, and was not spread over the laminate (i.e., the fingerprint pattern was easily visible).
Sebum Film Stain Resistance II (Degree of Noticeability/Visibility of Stains after Stain Removal Test)

Triolein was transferred to the surface of the hard coat layer of the multilayered resin product in the same manner as described above. A retainer (diameter: 30 mm) to which a wiper (“Handy Wiper” manufactured by Kuraray Co., Ltd.) was attached, was reciprocated on the surface of the hard coat layer of the multilayered resin product 50 times at a constant load (1 kg) and a constant speed (6000 mm/min). The surface of the hard coat layer was then observed with the naked eye at a distance of 10 cm under a three-wavelength fluorescent lamp (20 W) in a darkroom to confirm the triolein adhesion state. The haze of the multilayered resin product was measured using a haze meter (“NDH2000” manufactured by Nippon Denshoku Industries Co., Ltd.) in accordance with JIS K 7105, and an increase in haze (ΔH) due to the test was calculated.

A: The sebum film was almost completely removed, and the increase in haze ΔH was less than 0.05%.
B: The sebum film was almost removed, and the increase in haze ΔH was 0.05% or more and less than 0.2%.
C: The sebum film was removed to only a small extent (i.e., the surface was clouded white), and the increase in haze ΔH was 0.2% or more.

The evaluation results for the multilayered resin products of the examples and comparative examples are shown in Tables 1 and 2.

TABLE 1

| | | Example | | | | | | | | | | |
|---|---|---|---|---|---|---|---|---|---|---|---|---|
| | | 1 | 2 | 3 | 4 | 5 | 6 | 7 | 8 | 9 | 10 | 11 |
| Resin substrate | | PMMA | PMMA | PMMA | PMMA | PC | PET | PMMA | PMMA | PMMA | PMMA | PMMA |
| Composition of hard | | | | | | | | | | | | |
| coat layer | | | | | | | | | | | | |
| Content of component | | 4 | 3 | 2 | 4.5 | 6.5 | 0.2 | 1 | 2.5 | 1 | 5 | 8 |
| (B) with respect to | | | | | | | | | | | | |
| 100 parts by weight | | | | | | | | | | | | |
| of component (A) | | | | | | | | | | | | |
| Content of component | | 0 | 0 | 0.01 | 0.11 | 0.1 | 0.001 | 0.01 | 0.04 | 0.02 | 0.07 | 0.25 |
| (C) with respect to | | | | | | | | | | | | |
| 100 parts by weight | | | | | | | | | | | | |
| of component (A) | | | | | | | | | | | | |
| Bs/As | | 1.1 | 0.9 | 1.0 | 2.1 | 3 | 0.1 | 0.5 | 1.8 | 0.8 | 1.5 | 2.3 |
| Cs/As | | 0 | 0 | 0.005 | 0.05 | 0.1 | 0.001 | 0.005 | 0.03 | 0.015 | 0.02 | 0.07 |
| Thickness of hard | | 3 | 3 | 5 | 5 | 5 | 5 | 5 | 8 | 8 | 3 | 3 |
| coat layer (μm) | | | | | | | | | | | | |
| Optical | Transmit- | 91% | 91% | 90% | 90% | 91% | 92% | 91% | 90% | 90% | 91% | 91% |
| properties | tance | | | | | | | | | | | |
| | Haze | 0.1% | 0.1% | 0.2% | 0.2% | 0.2% | 0.1% | 0.1% | 0.2% | 0.2% | 0.1% | 0.1% |
| | value | | | | | | | | | | | |
| Appearance and | | None | None | None | None | None | None | None | None | None | None | None |
| surface cloudiness | | | | | | | | | | | | |
| Hard coat properties | | A | A | A | A | B | B | A | A | A | A | A |
| Sebum film | I | B | B | A | A | A | B | A | A | A | B | B |
| stain resistance | II | B | B | A | A | A | A | A | A | A | A | A |

TABLE 2

| | | Comparative Example | | | | Reference Example |
|---|---|---|---|---|---|---|
| | | 1 | 9 | 3 | 4 | 1 |
| Resin substrate | | PMMA | PMMA | PMMA | PMMA | PMMA |
| Composition of hard | | | | | | |
| coat layer | | | | | | |
| Content of component | | 13 | 0.1 | 0 | 9 | 1 |
| (B) with respect to | | | | | | |
| 100 parts by weight | | | | | | |
| of component (A) | | | | | | |
| Content of component | | 0 | 0.01 | 0.01 | 0.42 | 0.32 |
| (C) with respect to | | | | | | |
| 100 parts by weight | | | | | | |
| of component (A) | | | | | | |
| Bs/As | | 3.6 | 0.05 | 0 | 4.3 | 0.5 |
| Cs/As | | 0 | 0.005 | 0.005 | 0.2 | 0.3 |
| Thickness of hard | | 3 | 5 | 5 | 5 | 5 |
| coat layer (μm) | | | | | | |
| Optical | Transmit- | 88% | 91% | 91% | 87% | 91% |
| properties | tance | | | | | |
| | Haze | 3% | 0.1% | 0.1% | 3.7% | 0.1% |
| | value | | | | | |
| Appearance and | | Precipitated | None | None | Precipitated | None |
| surface cloudiness | | | | | | |
| Hard coat properties | | C | A | A | C | A |
| Sebum film | I | — | C | C | — | C |
| stain resistance | II | — | C | C | — | B |

As is clear from the results shown in Table 1, the multilayered resin products of Examples 1 and 2 including an appropriate amount of the fatty acid or the like (component (B)) exhibited good sebum film stain resistance (I). The multilayered resin products of Examples 3 to 11 including an appropriate amount of the modified polysiloxane compound (component (C)) in addition to the component (B) exhibited good sebum film stain resistance (I) and good sebum film stain resistance (II) (i.e., achieved a sufficient sebum film adhesion prevention. The multilayered resin products of Examples 1 to 11 maintained a practical level of performance in terms of the hard coat properties, appearance, total light transmittance, and haze.

The printing properties of the multilayered resin products of Examples 1 to 11 were evaluated, and found to be good without any problems.

1. A multilayered resin product comprising a resin substrate and a hard coat layer, each side or one side of the resin substrate being coated with the hard coat layer, the hard coat layer including a cured product of (A) a UV-curable compound and (B) a fatty acid, a fatty acid ester, or a derivative thereof, and a ratio “(Bs)/(As)” of a content (Bs) of the fatty acid, fatty acid ester, or derivative thereof to a content (As) of the cured product of the UV-curable compound in a surface area of the hard coat layer up to a depth of 100 nm being 0.07 to 3.3.

2. The multilayered resin product according to claim 1, wherein the hard coat layer further includes (C) a modified polysiloxane compound.

3. The multilayered resin product according to claim 1, wherein a ratio “(Cs)/(As)” of a content (Cs) of the modified polysiloxane compound to a content (As) of the cured product of the UV-curable compound in a surface area of the hard coat layer up to a depth of 100 nm is 0.0007 to 0.15.

4. The multilayered resin product according to claim 2, wherein the modified polysiloxane compound (C) is a polyether-modified polydimethylsiloxane and/or a polyether-modified polymethylalkylsiloxane.

5. The multilayered resin product according to claim 1, wherein a ratio “(Br)/(Ar)” of a content (Br) of the fatty acid, fatty acid ester, or derivative thereof to a content (Ar) of the cured product of the UV-curable compound in an area of the hard coat layer other than a surface area up to a depth of 100 nm is 0.08 or less.

6. The multilayered resin product according to claim 1, wherein a ratio “(Br)/(Ar)” of a content (Br) of the fatty acid, fatty acid ester, or derivative thereof to a content (Ar) of the cured product of the UV-curable compound in an area of the hard coat layer other than a surface area up to a depth of 100 nm is 0.03 or less.

7. The multilayered resin product according to claim 1, wherein the resin substrate includes an acrylic resin or a polycarbonate resin.

8. An image display comprising the multilayered resin product according to claim 1 in a display section of the image display.

9. The image display according to claim 8, the image display being a cell phone.

10. The image display according to claim 8, the image display being a liquid crystal display.
